(19) United States
(12) Patent Application Publication
(10) Pub. No.: US 2025/0390113 A1
(43) Pub. Date: Dec. 25, 2025

(54) PARKING ROBOT AND CONTROL METHOD THEREOF

(71) Applicant: HL Robotics Co., Ltd., Seongnam-si (KR)

(72) Inventor: Sunguk IN, Pyeongtaek-si (KR)

(73) Assignee: HL Robotics Co., Ltd., Seongnam-si (KR)

(21) Appl. No.: 19/244,404

(22) Filed: Jun. 20, 2025

(30) Foreign Application Priority Data
Jun. 20, 2024 (KR) 10-2024-0080603

(51) Int. Cl. G05D 1/667; G05D 1/243; G05D 1/698; G05D 107/00; G05D 111/10; G06T 7/73; H04N 23/56; H04N 23/74

(52) U.S. Cl. CPC G05D 1/667; G05D 1/243; G05D 1/6985; G06T 7/73; H04N 23/56; H04N 23/74; G05D 2107/95; G05D 2111/17; G06T 2207/30204; G06T 2207/30252

(57) ABSTRACT

A parking robot includes: a driving device; a camera; a communicator; and a controller electrically connected to the driving device, the camera, and the communicator, and wherein the controller is configured to, while the parking robot controls the driving device to move the parking robot under a target vehicle, identify one or more markers positioned on a following parking robot following the parking robot based on image data obtained through the camera to identify a relative posture of the one or more markers with respect to the parking robot, receive positioning information of the following parking robot from the following parking robot through the communicator, and determine a position of the parking robot under the target vehicle based on the relative posture of the one or more markers with respect to the parking robot and the positioning information of the following parking robot.

### CROSS-REFERENCE TO RELATED APPLICATION

This application is based on and claims priority under 35 U.S.C. § 119 to Korean Patent Application No. 10-2024-0080603, filed on Jun. 20, 2024 in the Korean Intellectual Property Office, the disclosure of which is incorporated by reference herein in its entirety.

### BACKGROUND

### 1. Field

The disclosure relates to a parking robot and a control method thereof.

### 2. Description of the Related Art

Vehicles are the commonly used means of transportation in modern society, and vehicle usage is continuously increasing. The increase in vehicle usage causes the lack of parking spaces for vehicles. Accordingly, parking areas are becoming narrower to accommodate more vehicles, especially in cities where many vehicles are on the road.

As parking areas become narrower, drivers are required to be highly skilled in parking their vehicles, which can eventually lead to inexperienced drivers causing major and minor accidents during parking.

Mechanical parking facilities have been developed and utilized to save the parking space and enable efficient parking regardless of the driver's skill level. However, the mechanical parking facilities have the disadvantage of being limited in the size of vehicles that can be parked.

Accordingly, there is a growing demand for parking assistance equipment that can maximize the use of existing parking spaces regardless of vehicle size while not requiring the driver's parking skills.

### SUMMARY

Therefore, it is an aspect of the disclosure to provide a parking robot for entering under a vehicle, moving the vehicle to a parking area, and parking the vehicle, and a control method of the parking robot.

It is an aspect of the disclosure to provide a parking robot for providing a reliable positioning value through positioning supplementation between parking robots, for example, a first parking robot and a second parking robot, and a control method of the parking robot.

Additional aspects of the disclosure will be set forth in part in the description which follows and, in part, will be obvious from the description, or may be learned by practice of the disclosure.

A parking robot according to an aspect of the disclosure may include: a driving device configured to move the parking robot; a camera installed on the parking robot and configured to obtain image data; a communicator configured to communicate with an external device; and a controller electrically connected to the driving device, the camera, and the communicator, and wherein the controller is configured to, while the parking robot controls the driving device to move the parking robot under a target vehicle, identify one or more markers positioned on a following parking robot following the parking robot based on the image data obtained through the camera to identify a relative posture of the one or more markers with respect to the parking robot, receive positioning information of the following parking robot from the following parking robot through the communicator, determine a position of the parking robot under the target vehicle based on the relative posture of the one or more markers with respect to the parking robot and the positioning information of the following parking robot, and control the driving device to move the parking robot to a preset lower position of the target vehicle based on the determined position.

The positioning information of the following parking robot may include position information of the following parking robot and information about a relative posture of the following parking robot with respect to the parking robot.

The parking robot may further include a steering device, and wherein the controller may be configured to determine a posture of the parking robot based on the relative posture of the one or more markers with respect to the parking robot and the positioning information of the following parking robot, and control the steering device to adjust a moving direction of the parking robot based on the determined position and the determined posture.

The controller may be configured to control the parking robot to move to a preset first lower position of the target vehicle and then temporarily stop, control the driving device to move the parking robot from the preset first lower position of the target vehicle to a preset second lower position of the target vehicle, and receive positioning information of the following parking robot through the communicator while the parking robot moves from the preset first lower position to the preset second lower position.

The controller may be configured to control the driving device to move the parking robot from the preset first lower position toward the preset second lower position, based on at least one of a distance to the following parking robot identified based on the image data obtained through the camera or information received from the following parking robot through the communicator.

The preset first lower position may correspond to a position of front wheels of the target vehicle, and the preset second lower position may correspond to a position of rear wheels of the target vehicle.

The parking robot may further include an Inertial Measurement Unit, and the controller may be configured to determine the position of the parking robot under the target vehicle further based on data obtained through the inertial measurement unit.

The parking robot may further include a lidar, and the controller may be configured to control the driving device to move the parking robot under the target vehicle based on at least one of point cloud data obtained through the lidar or the image data obtained through the camera.

One or more lighting devices may be installed in a main body of the parking robot, a marker may be positioned above or around each of the one or more lighting devices, and the controller may be configured to turn on the one or more lighting devices based on the parking robot moving under the target vehicle.

A parking robot according to an aspect of the disclosure may include: a driving device configured to move the parking robot; a camera installed in the parking robot and configured to obtain image data; a lidar installed in the parking robot and configured to obtain point cloud data; a communicator configured to communicate with an external device; and a controller electrically connected to the driving device, the camera, the lidar, and the communicator, wherein the controller is configured to obtain position information based on at least one of the image data obtained through the camera or the point cloud data obtained through the lidar, obtain information about a relative posture with respect to a preceding parking robot moving under a target vehicle, based on the image data obtained through the camera, and transmit the position information and the information about the relative posture with respect to the preceding parking robot to the preceding parking robot through the communicator, while controlling the driving device to move the parking robot under the target vehicle along the preceding parking robot.

The controller may be configured to control the driving device to move the parking robot to a preset first lower position corresponding to a position of front wheels of the target vehicle, along the preceding parking robot moving from the preset first lower position toward a preset second lower position corresponding to a position of rear wheels of the target vehicle.

The controller may be configured to control the driving device to move the parking robot to the preset first lower position of the target vehicle, based on at least one of the image data obtained through the camera or information received from the preceding parking robot through the communicator.

The controller may be configured to obtain information about a relative posture with respect to the preceding parking robot, based on recognition of one or more markers of the preceding parking robot, included in the image data obtained through the camera.

A control method of a parking robot according to an aspect of the disclosure may include: controlling a driving device of the parking robot to move the parking robot under a target vehicle; identifying, while controlling the driving device, one or more markers positioned on a following parking robot following the parking robot based on image data obtained through a camera of the parking robot to identify a relative posture of the one or more markers with respect to the parking robot, and receiving positioning information of the following parking robot from the following parking robot through a communicator of the parking robot; determining a position of the parking robot under the target vehicle, based on the relative posture of the one or more markers with respect to the parking robot and the positioning information of the following parking robot; and controlling the driving device to move the parking robot to a preset lower position of the target vehicle based on the determined position.

The positioning information of the following parking robot may include position information of the following parking robot and information about a relative posture of the following parking robot with respect to the parking robot.

The control method of the parking robot may further include: determining a posture of the parking robot based on the relative posture of the one or more markers with respect to the parking robot and the positioning information of the following parking robot, and controlling a steering device of the parking robot to adjust a moving direction of the parking robot based on the determined position and the determined posture.

The controlling of the driving device may include: controlling the parking robot to move to a preset first lower position of the target vehicle and then temporarily stop, and controlling the parking robot to move from the preset first lower position of the target vehicle to a preset second lower position of the target vehicle, and the positioning information of the following parking robot may be received while the parking robot moves from the preset first lower position to the preset second lower position.

The controlling of the parking robot to move from the preset first lower position to the preset second lower position may be performed based on at least one of a distance to the following parking robot identified based on the image data obtained through the camera or information received from the following parking robot through the communicator.

The preset first lower position may correspond to a position of front wheels of the target vehicle, and the preset second lower position may correspond to a position of rear wheels of the target vehicle.

The control method of the parking robot may further include turning on one or more lighting devices installed in a main body of the parking robot based on the parking robot moving under the target vehicle, and a marker may be positioned above or around each of the one or more lighting devices.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 shows a first parking robot and a second parking robot according to an embodiment.

FIG. 2 shows a first parking robot and a second parking robot according to an embodiment.

FIG. 3 is a block diagram showing configurations of a first parking robot and a second parking robot according to an embodiment.

FIGS. 4A to 4E are a view for describing operations of a first parking robot and a second parking robot according to an embodiment.

FIG. 5 is a flowchart illustrating an operation of a first parking robot according to an embodiment.

FIG. 6 is a flowchart illustrating an operation of a second parking robot according to an embodiment.

### DETAILED DESCRIPTION

Like reference numerals refer to like components throughout the specification. This specification does not describe all the components of the embodiments, and duplicative contents between embodiments or general contents in the technical field of the present disclosure will be omitted. The terms ‘part,’ ‘module,’ ‘member,’ and ‘block’ used in this specification may be embodied as software or hardware, and it is also possible for a plurality of ‘parts,’ ‘modules,’ ‘members,’ and ‘blocks’ to be embodied as one component, or one ‘part,’ ‘module,’ ‘member,’ and ‘block’ to include a plurality of components according to embodiments.

Throughout the specification, when a part is referred to as being ‘connected’ to another part, it includes not only a direct connection but also an indirect connection, and the indirect connection includes connecting through a wireless network.

Also, when it is described that a part ‘includes’ a component, it means that the part may further include other components, not excluding the other components unless specifically stated otherwise.

Throughout the specification, when a member is described as being ‘on’ another member, this includes not only a case in which the member is in contact with the other member but also a case in which another member is present between the two members.

The terms first, second, etc. are used to distinguish one component from another component, and the components are not limited by the above-mentioned terms.

The singular forms ‘a,’ ‘an,’ and ‘the’ include plural referents unless the context clearly dictates otherwise.

In each operation, an identification numeral is used for convenience of explanation, the identification numeral does not describe the order of the operations, and each operation may be performed differently from the order specified unless the context clearly states a particular order.

The disclosure may provide two parking robots, for example, a first parking robot and a second parking robot for entering under a vehicle and moving the vehicle to a parking area in cooperation with each other, and more particularly, the disclosure may provide technology by which the first and second parking robots are capable of accurately moving to a preset position under the vehicle.

The disclosure may enable the first and second parking robots to accurately move to the preset position under the vehicle through autonomous driving and lift the vehicle from below. For autonomous driving of the first and second parking robots under the vehicle, accurate localization of the first and second parking robots, that is, obtaining accurate positioning information of the first and second parking robots is essential.

For example, in the case in which each of the first and second parking robots obtains its own positioning information only by using its own sensing device while moving under the vehicle, the obtained positioning information may have low reliability.

Actually, in the case in which each of the first and second parking robots moving under the vehicle obtains positioning information by using its own sensing device, for example, a cameras and/or a lidar, reliability may deteriorate significantly due to a limited field of view, proximity to the ground, multipath interference by signals reflected from structures around a vehicle body, and/or the influence of dirt or dust on the ground, which may result in a great error from actual positioning information. This may reduce accuracy in localization of each of the first and second parking robots under a vehicle, which causes driving errors of the first and second parking robots.

Also, even in the case in which each of the first and second parking robots moving under a vehicle obtains its own positioning information based on data obtained by using Wheel Odometry technology and/or through an Inertial Measurement Unit (IMU), a drift error may be generated, which may result in accumulation of errors.

The disclosure considering these may provide technology of enabling first and second parking robots to move to preset positions under a vehicle by obtaining reliable positioning information under the vehicle in cooperation with each other.

Hereinafter, an operation principle and embodiments of the disclosure will be described with reference to the accompanying drawings.

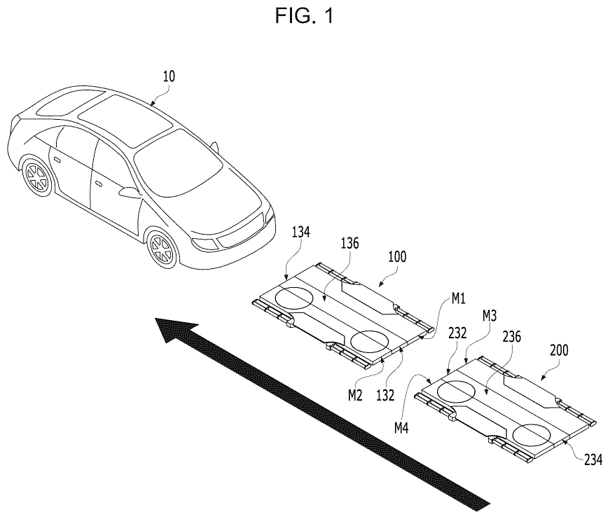

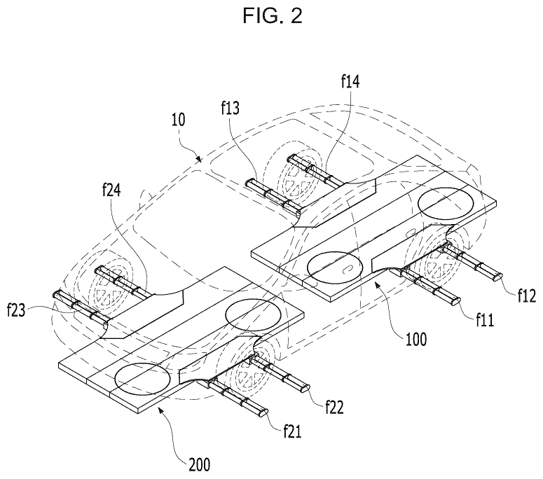

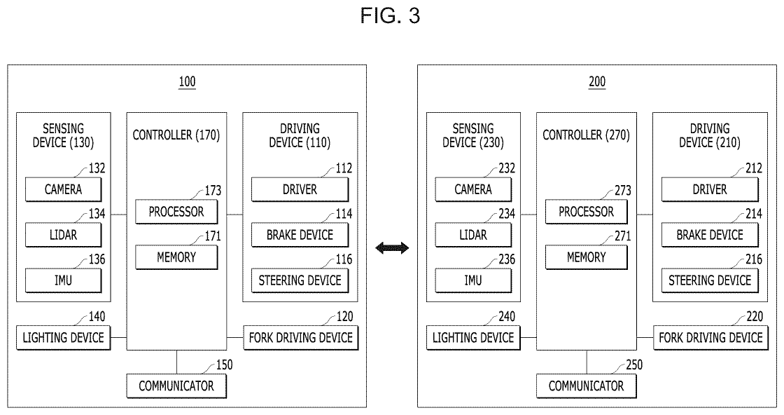

FIG. 1 shows a first parking robot and a second parking robot according to an embodiment. FIG. 2 shows a first parking robot and a second parking robot according to an embodiment. FIG. 3 is a block diagram showing configurations of a first parking robot and a second parking robot according to an embodiment.

Referring to FIGS. 1 and 2, a first parking robot 100 and a second parking robot 200 may park a vehicle (also referred to as a target vehicle) 10 in a parking area in cooperation with each other.

For example, the first parking robot 100 and the second parking robot 200 may move under the vehicle 10, that is, enter under the vehicle 10, lift the vehicle 10, and then park the vehicle 10 in a parking area.

Referring to FIGS. 1 and 2, the first parking robot 100 may be a preceding parking robot, and the second parking robot 200 may be a following parking robot following the first parking robot 100.

Referring to FIG. 3, the first parking robot 100 may include a driving device 110, a fork driving device 120, a sensing device 130, a lighting device 140, a communicator 150, and/or a controller 170.

The driving device 110 may move the first parking robot 100, stop the first parking robot 100, and/or change a moving direction of the first parking robot 100.

The driving device 110 may include a driver 112, a brake device 114, and/or a steering device 116.

The driver 112 may move the first parking robot 100. For example, the driver 112 may include a motor (or referred to as an electric motor), and provide a driving force to the motor to rotate a wheel (or referred to as an electric wheel) of the first parking robot 100, in order to move the first parking robot 100.

For example, the first parking robot 100 may include one or a plurality of wheels according to a design.

The brake device 114 may stop the first parking robot 100. For example, the brake device 114 may include components, such as a brake pad and a disk, to stop the first parking robot 100.

The steering device 116 may change a moving direction of the first parking robot 100. For example, the steering device 116 may change the moving direction of the first parking robot 100 by including a component, such as a motor or a hydraulic system for controlling a direction of the wheel of the first parking robot 100.

The sensing device 130 may include one or more sensors capable of generating an electrical signal or data corresponding to a state of the first parking robot 100 and/or an external state of the first parking robot 100.

The fork driving device 120 may include one or more motors capable of providing a driving force for moving a plurality of forks f11, f12, f13, and f14 of the first parking robot 100.

Referring to FIG. 2, the first parking robot 100 may include the plurality of forks f11, f12, f13, and f14 that extend from both sides of a main body to support both rear wheels of the vehicle 10.

For example, each of the forks f11, f12, f13, and f14 of the first parking robot 100 may be implemented as a structure capable of changing from a folded state to an unfolded state or from an unfolded state to a folded state based on control on the fork driving device 140 by the controller 170.

Also, each of the forks f11, f12, f13, and f14 of the first parking robot 100 may be implemented as a structure capable of being lifted upward and lowered downward in an unfolded state based on control on the fork driving device 140 by the controller 170.

As another example, each of the forks f11, f12, f13, and f14 of the first parking robot 100 may be implemented as a structure capable of extending outward from the main body and contracting toward the main body from a state extending outward based on control on the fork driving device 140 by the controller 170.

Also, each of the forks f11, f12, f13, and f14 of the first parking robot 100 may be implemented as a structure capable of being lifted upward and lowered downward in a state extending outward from the main body based on control on the fork driving device 140 by the controller 170.

The sensing device 130 may include a camera 132, a lidar 134, and/or an IMU 136.

The camera 132 may obtain image data about surroundings of the first parking robot 100. For example, the camera 132 may include a plurality of lenses (not shown), an image sensor, and/or an image processor (not shown).

One or a plurality of cameras 132 may be positioned on the main body of the first parking robot 100.

Referring to FIG. 1, the camera 132 may be positioned on the main body of the first parking robot 100 in such a way as to have a field of view toward a second direction (or referred to as a rear direction) that is opposite to a first direction (or referred to as a front direction) in which the first parking robot 100 moves.

The lidar 134 may generate point cloud data by scanning surroundings of the first parking robot 100.

One or a plurality of lidars 134 may be positioned on the main body of the first parking robot 100.

Referring to FIG. 1, the lidar 134 may be positioned on the main body of the first parking robot 100 in such a way as to have a field of view toward the first direction in which the first parking robot 100 moves.

The IMU 136 may obtain motion status data such as a speed, a direction, and/or acceleration of the first parking robot 100 and may be positioned in the main body of the first parking robot 100.

Referring to FIG. 1, the IMU 136 may be positioned at a center of the main body of the first parking robot 100.

The lighting device 140 may include one or more light sources or a light source array and may be positioned on the main body of the first parking robot 100. For example, the lighting device 140 may be one of various existing lighting devices (for example, a Light-Emitting Diode (LED) and a Halogen Lamp).

Referring to FIG. 1, a marker, for example, a first marker M1 and a second marker M2 may be positioned on the first parking robot 100, and as not shown, the lighting device 140 may be positioned below or around the first marker M1 and the second marker M2 on the main body of the first parking robot 100 in order to secure a field of view with respect to the first marker M1 and the second marker M2.

For example, each of the first marker M1 and the second marker M2 may be produced to include a preset pattern, for example, a pattern having four corner points.

The communicator 150 may support establishment of a wireless communication channel between the first parking robot 100 and the second parking robot 200 and communications through the established communication channel, and may include a communication circuit and/or a control circuit capable of controlling an operation of the communication circuit. The communicator 150 may include a cellular communication module, a Wireless-Fidelity (Wi-Fi) communication module, a short-range wireless communication module (for example, Bluetooth communication module), and/or a global navigation satellite system (GNSS) communication module, and may communicate with the second parking robot 200 through any module.

The controller 170 may be electrically and/or communicatively connected to components of the first parking robot 100, for example, the driving device 110, the fork driving device 120, the sensing device 130, the lighting device 140, and/or the communicator 150 to control the individual components.

For example, the controller 170 may process data obtained through the sensing device 130, and process data received from an external device, for example, the second parking robot 200 through the communicator 150. Also, the controller 170 may control a control signal to a corresponding component among the driving device 110, the fork driving device 120, the sensing device 130, the lighting device 140, and/or the communicator 150 based on the processed result on the data obtained through the sensing device 130 and/or the processed result on the data received through the communicator 150.

The controller 170 may obtain positioning information including posture information of the first parking robot 100 and information about a relative posture with respect to the second parking robot 200 based on data obtained by the sensing device 130, for example, the camera 132, the lidar 134, and/or the IMU 136 by using the Wheel Odometry technology. For example, the posture information of the first parking robot 100 may include position information of the first parking robot 100, and the information about the relative posture with respect to the second parking robot 200 may include information about a relative position with respect to the second parking robot 200.

The controller 170 may move the vehicle 10 through cooperative control with the second parking robot 200 via the communicator 150 and park the vehicle 10 in a designated parking area. At this time, data obtained through the sensing device 130 may be additionally used.

The controller 170 may control, based on data obtained through the sensing device 130 and/or data communication with the second parking robot 200 via the communicator 150, the driver 112 included in the driving device 110 to move the first parking robot 100 under the vehicle 10.

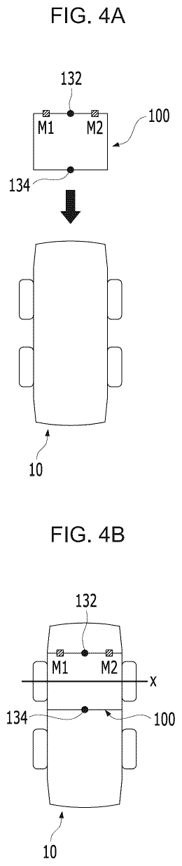

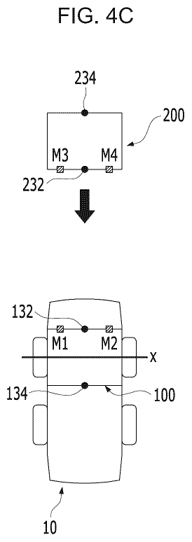

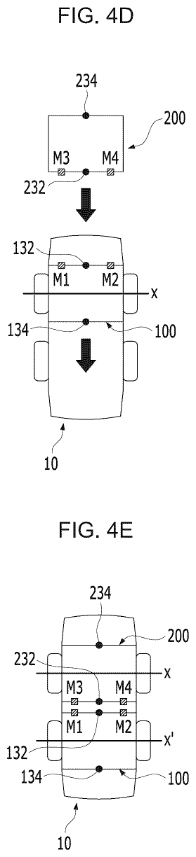

Details about an embodiment related to a movement of the first parking robot 100 will be described in detail with reference to FIGS. 4A to 6, below.

The controller 170 may control the fork driving device 120 through cooperative control with the second parking robot 200 via the communicator 150 to cause the plurality of forks f11, f12, f13, and f14 to support both rear wheels of the vehicle 10 and then lift the plurality of forks f11, f12, f13, and f14 upward. At this time, the second parking robot 200 may cause a plurality of forks f21, f22, f23, and f24 to support both front wheels of the vehicle 10 and then lift the plurality of forks f21, f22, f23, and f24 upward.

Also, after the plurality of forks f11, f12, f13, and f14 are lifted upward, the controller 170 may control the driver 112 included in the driving device 110 through cooperative control with the second parking robot 200 via the communicator 150 to move the first parking robot 100 (to the parking area. At this time, the second parking robot 200 may also lift the plurality of forks f21, f22, f23, and f24 upward and move to the parking area.

Also, after the first parking robot 100 moves to the parking area, the controller 170 may perform control of lowering the plurality of forks f11, f12, f13, and f14 and releasing the plurality of forks f11, f12, f13, and f14 supporting both rear wheels through cooperative control with the second parking robot 200 via the communicator 150. At this time, the second parking robot 200 may also lower the plurality of forks f11, f22, f23, and f24 and release the plurality of forks f21, f22, f23, and f24 supporting both front wheels.

The controller 170 may include a memory 171 and/or a processor 173.

The memory 171 may store a software program for the first parking robot 100.

The memory 171 may store data and/or a program for processing each piece of data (data obtained through the sensing device 130 and/or data received through the communicator 150).

The memory 171 may temporarily memorize each piece of data, and temporarily memorize a processed result on each piece of data by the processor 173.

The memory 171 may include a volatile memory, such as Static Random Access Memory (S-RAM) and Dynamic Random Access Memory (D-RAM), and a non-volatile memory, such as a flash memory, Read Only Memory (ROM), and Erasable Programmable Read Only Memory (EPROM).

The processor 173 may process each piece of data and provide signals for respectively controlling the driving device 110, the fork driving device 120, the sensing device 130, the lighting device 140, and/or the communicator 150 to the corresponding devices. For example, the processor 173 may include a Micro Control Unit (MCU).

The second parking robot 200 may include a driving device 210, a fork driving device 220, a sensing device 230, a lighting device 240, a communicator 250, and/or a controller 270.

The driving device 210 may move the second parking robot 200, stop the second parking robot 200, and/or change a moving direction of the second parking robot 200.

The driving device 210 may include a driver 212, a brake device 214, and/or a steering device 216.

The driver 212 may move the second parking robot 200. For example, the driver 212 may include a motor (or referred to as an electric motor), and provide a driving force to the motor to rotate a wheel (or referred to as an electric wheel) of the second parking robot 200, in order to move the second parking robot 200. For example, the second parking robot 200 may include one or a plurality of wheels according to a design.

The brake device 214 may stop the second parking robot 200. For example, the brake device 214 may include components, such as a brake pad and a disk, to stop the second parking robot 200.

The steering device 216 may change a moving direction of the second parking robot 200. For example, the steering device 216 may change the moving direction of the second parking robot 200 by including a component, such as a motor or a hydraulic system for controlling a direction of the wheel of the second parking robot 200.

The sensing device 230 may include one or more sensors capable of generating an electrical signal or data corresponding to a state of the second parking robot 200 and/or an external state of the second parking robot 200.

The fork driving device 240 may include one or more motors capable of providing a driving force for moving the plurality of forks f21, f22, f23, and f24 of the second parking robot 200.

Referring to FIG. 2, the second parking robot 200 may include the plurality of forks f21, f22, f23, and f24 that extend from both sides of a main body to support both front wheels of the vehicle 10.

For example, each of the forks f21, f22, f23, and f24 of the second parking robot 200 may be implemented as a structure capable of changing from a folded state to an unfolded state or from an unfolded state to a folded state based on control on the fork driving device 240 by the controller 270.

Also, each of the forks f21, f22, f23, and f24 of the second parking robot 200 may be implemented as a structure capable of being lifted upward and lowered downward in an unfolded state based on control on the fork driving device 240 by the controller 270.

As another example, each of the forks f21, f22, f23, and f24 of the second parking robot 200 may be implemented as a structure capable of extending outward from the main body and contracting toward the main body from a state extending outward based on control on the fork driving device 240 by the controller 270.

Also, each of the forks f21, f22, f23, and f24 of the second parking robot 200 may be implemented as a structure capable of being lifted upward and lowered downward in a state extending outward from the main body based on control on the fork driving device 240 by the controller 270.

The sensing device 230 may include a camera 232, a lidar 234, and/or an IMU 236.

The camera 232 may obtain image data about surroundings of the second parking robot 200. For example, the camera 232 may include a plurality of lenses (not shown), an image sensor, and/or an image processor (not shown).

One or a plurality of cameras 232 may be positioned on the main body of the second parking robot 200.

Referring to FIG. 1, the camera 232 may be positioned on the main body of the second parking robot 200 in such a way as to have a field of view toward the first direction (or referred to as the front direction) in which the second parking robot 200 moves.

The lidar 234 may generate point cloud data by scanning surroundings of the second parking robot 200.

One or a plurality of lidars 234 may be positioned on the main body of the second parking robot 200.

Referring to FIG. 1, the lidar 234 may be positioned on the main body of the second parking robot 200 in such a way as to have a field of view toward the second direction (or referred to as the rear direction) that is opposite to the first direction in which the second parking robot 200 moves.

The IMU 236 may obtain motion status data such as a speed, a direction, and/or acceleration of the second parking robot 200 and may be positioned in the main body of the second parking robot 200.

Referring to FIG. 1, the IMU 236 may be positioned at a center of the main body of the second parking robot 200.

The lighting device 240 may include one or more light sources or a light source array and may be positioned on the main body of the second parking robot 200. For example, the lighting device 240 may be one of various existing lighting devices (for example, a LED and a Halogen Lamp).

Referring to FIG. 1, a marker, for example, a first marker M3 and a second marker M4 may be positioned on the second parking robot 200, and as not shown, the lighting device 240 may be positioned below or around the first marker M3 and the second marker M4 on the main body of the second parking robot 200 in order to secure a field of view with respect to the first marker M3 and the second marker M4.

For example, each of the first marker M3 and the second Marker M4 may be produced to include a preset pattern, for example, a pattern having four corner points.

The communicator 250 may support establishment of a wireless communication channel between the first parking robot 100 and the second parking robot 200 and communications through the established communication channel, and may include a communication circuit and/or a control circuit capable of controlling an operation of the communication circuit. The communicator 250 may include a cellular communication module, a Wi-Fi communication module, a short-range wireless communication module (for example, Bluetooth communication module), and/or a GNSS communication module, and may communicate with the second parking robot 200 through any module.

The controller 270 may be electrically and/or communicatively connected to components of the second parking robot 200, for example, the driving device 210, the fork driving device 220, the sensing device 230, the lighting device 240, and/or the communicator 250 to control the individual components.

For example, the controller 270 may process data obtained through the sensing device 230, and process data received from an external device, for example, the first parking robot 100 through the communicator 250. Also, the controller 270 may control a control signal to a corresponding component among the driving device 210, the fork driving device 220, the sensing device 230, the lighting device 240, and/or the communicator 250 based on the processed result on the data obtained through the sensing device 230 and/or the processed result on the data received through the communicator 250.

The controller 270 may obtain positioning information including posture information of the second parking robot 200 and information about a relative posture with respect to the first parking robot 200 based on data obtained by the sensing device 230, for example, the camera 232, the lidar 234, and/or the IMU 236 by using the Wheel Odometry technology. For example, the posture information of the second parking robot 200 may include position information of the second parking robot 200, and the information about the relative posture with respect to the first parking robot 100 may include information about a relative position with respect to the first parking robot 100.

The controller 270 may move the vehicle 10 through cooperative control with the first parking robot 100 via the communicator 250 and park the vehicle 10 in a designated parking area. At this time, data obtained through the sensing device 230 may be used.

The controller 270 may control, based on data obtained through the sensing device 230 an/or data communication with the first parking robot 100 via the communicator 250, the driver 212 included in the driving device 210 to move the second parking robot 200 under the vehicle 10.

Details about an embodiment related to a movement of the second parking robot 200 will be described in detail with reference to FIGS. 4A to 6, below.

The controller 270 may control the fork driving device 220 through cooperative control with the first parking robot 100 via the communicator 250 to cause the plurality of forks f21, f22, f23, and f24 to support both front wheels of the vehicle 10 and then lift the plurality of forks f21, f22, f23, and f24 upward. At this time, the first parking robot 100 may cause the plurality of f11, f12, f13, and f14 to support both rear wheels of the vehicle 10 and then lift the plurality of forks f11, f12, f13, and f14 upward.

Also, after the plurality of forks f21, f22, f23, and f24 are lifted upward, the controller 170 may control the driver 212 included in the driving device 210 through cooperative control with the first parking robot 100 via the communicator 250 to move the second parking robot 200 to the parking area. At this time, the first parking robot 100 may also lift the plurality of forks f11, f12, f13, and f14 upward and move to the parking area.

Also, after the second parking robot 200 moves to the parking area, the controller 270 may lower the plurality of forks f21, f22, f23, and f24 through cooperative control with the first parking robot 100 via the communicator 250 and control the plurality of forks f21, f22, f23, and f24 to release both front wheels. At this time, the first parking robot 100 may also lower the plurality of forks f11, f12, f13, and f14 and control the plurality of forks f11, f12, f13, and f14 to release both rear wheels.

The controller 270 may include a memory 271 and/or a processor 273.

The memory 271 may store a software program for the second parking robot 200.

The memory 271 may store data and/or a program for processing each piece of data (data obtained through the sensing device 230 and/or data received through the communicator 250).

The memory 271 may temporarily memorize each piece of data and temporarily memorize a processed result on each piece of data by the processor 273.

The memory 271 may include a volatile memory, such as S-RAM and D-RAM, and a non-volatile memory, such as a flash memory, ROM, and EPROM.

The processor 273 may process each piece of data and provide signals for respectively controlling the driving device 210, the fork driving device 220, the sensing device 230, the lighting device 240, and/or the communicator 250 to the corresponding devices. For example, the processor 273 may include a MCU.

FIGS. 4A to 4E are a view for describing operations of the first parking robot 100 and the second parking robot 200 according to an embodiment.

Referring to FIG. 4A, according to identifying of a vehicle 10 as a target to be parked, the first parking robot 100 may begin entering under the vehicle 10, that is, begin moving under the vehicle 10.

For example, in the main body of the first parking robot 100, the lidar 134 may be positioned to have a field of view toward the first direction (or referred to as the front direction) in which the first parking robot 100 moves, and the camera 132 may be positioned to have a field of view toward the second direction (also referred to as the rear direction) that is opposite to the first direction. Also, the first marker M1 and the second marker M2 may be positioned at both end portions of the main body of the first parking robot 100 with the camera 132 in between. Also, the IMU 136 may be positioned inside the main body of the first parking robot 100, which is not shown in FIG. 4A.

The first parking robot 100 may begin moving under the vehicle 10 by identifying its own position and/or an entry target position under the vehicle 10 based on data obtained through the camera 132 and/or the lidar 134.

For example, the first parking robot 100 may identify its own position and/or an entry position under the vehicle 10 by additionally using data obtained through the IMU 136, as well as data obtained through the camera 132 and/or the lidar 134.

Technology (for example, lidar map mapping technology and/or sensor fusion technology) for identifying a position of an object including a camera and/or a lidar and identifying a position of a target object based on data obtained through the camera and/or lidar is known in the art, and therefore, a detailed description thereof will be omitted.

Referring to FIG. 4B, the first parking robot 100 may enter a standby state, that is, temporarily stop based on a movement to a preset first lower position of the vehicle 10.

For example, the preset first lower position may correspond to a position of the front wheels of the vehicle 10. The first parking robot 100 may temporarily stop when a center of the main body of the first parking robot 100 matches with a center of a horizontal line x connecting central axes of the left and right front wheels of the vehicle 10.

For example, the first parking robot 100 may identify, when entering under the vehicle 10, its own position and/or the preset first lower position of the vehicle 10 based on data obtained through the camera 132, move to the first lower position, and then temporarily stop.

As another example, the first parking robot 100 may identify its own position and/or the first lower position of the vehicle 10 by additionally using data obtained through the IMU 136, as well as data obtained through the camera 132.

Referring to FIG. 4C, based on the first parking robot 100 being located at the preset first lower position and/or being in a standby state at the preset first lower position, the second parking robot 200 may begin moving under the vehicle 10 and simultaneously identify a relative posture with respect to the first parking robot 100. For example, the relative posture may include a relative position.

For example, the first parking robot 100 may communicate with the second parking robot 200, and based on the first parking robot 100 arriving at the preset first lower position and/or entering a standby state at the first lower position, the first parking robot 100 may transmit, to the second parking robot 200, a signal for causing the second parking robot 200 to begin moving. The second parking robot 200 may begin moving based on reception of the signal for causing the second parking robot 200 to begin moving from the first parking robot 100.

In the second parking robot 200, the camera 232 may be positioned to have a field of view toward the first direction in which the second parking robot 200 moves, and the lidar 234 may be positioned to have a field of view toward the second direction that is opposite to the first direction. Also, the first marker M3 and the second marker M4 may be positioned at both end portions of the main body of the second parking robot 200 with the camera 232 in between. Also, the IMU 236 may be positioned inside the main body of the second parking robot 200, which is not shown in FIG. 4C.

For example, the second parking robot 200 may identify its own position, an entry position under the vehicle 10, and/or a relative posture with respect to the first parking robot 100 based on data obtained through the sensing device 230, for example, the camera 232 and/or the lidar 234, in response to reception of a signal from the first parking robot 100, and may begin moving under the vehicle 10. For example, the relative posture may include a relative position.

As another example, the second parking robot 200 may identify its own position, a target position under the vehicle 10, and/or a relative posture with respect to the first parking robot 100 by additionally using data obtained through the IMU 236, as well as data obtained through the camera 232 and/or the lidar 234.

Technology (for example, sensor fusion technology) for identifying a position of an object including a camera and/or a lidar and identifying a position of a target object based on data obtained through the camera and/or lidar is known in the art, and therefore, a detailed description thereof will be omitted. Technology for identifying a position of a corresponding object and a position of a target object by additionally using an IMU in addition to a camera and/or a lidar is also known in the art, and therefore, a detailed description thereof will be omitted.

For example, the second parking robot 200 may identify the first and second markers M1 and M2 of the first parking robot 100, included in image data obtained through the camera 232, and identify a relative posture with respect to the first parking robot 100 based on the first and second markers M1 and M2.

For example, the second parking robot 200 may identify a relative posture of the camera 232 of the second parking robot 200 with respect to the first and second markers M and M2 by identifying the patterns included in the first and second markers M1 and M2, and identify a relative posture with respect to the first parking robot 100 by identifying the relative posture of the camera 232 of the second parking robot 200 with respect to the first and second markers M1 and M2.

Referring to FIG. 4D, the first parking robot 100 and the second parking robot 200 may move simultaneously, and, while the first and second parking robots 100 and 200 move, the second parking robot 200 may transmit, to the first parking robot 100, position information of the second parking robot 200 and information about a relative posture of the second parking robot 200 with respect to the first parking robot 100. For example, the position information of the second parking robot 200 and the information about the relative posture of the second parking robot 200 with respect to the first parking robot 100 are referred to as positioning information.

For example, the first parking robot 100 may identify a distance to the second parking robot 200 while the second parking robot 200 moves, and when the distance to the second parking robot 200 becomes a preset distance, the first parking robot 100 may begin moving and move together with the second parking robot 200.

For example, the first parking robot 100 may identify a distance to the second parking robot 200 based on positioning information received from the second parking robot 200, and when the distance to the second parking robot 200 becomes the preset distance, the first parking robot 100 may begin moving and move together with the second parking robot 200.

Also, the second parking robot 200 may identify a distance to the first parking robot 100 based on image data obtained through the camera 232, and, when the distance to the first parking robot 100 becomes the preset distance, the second parking robot 200 may begin moving and move together with the first parking robot 100. For example, the second parking robot 200 may determine a distance to the first parking robot 100 by identifying the first and second markers M1 and M2 of the first parking robot 100 included in image data.

Meanwhile, because the first parking robot 100 moves under the vehicle 10 while the first parking robot 100 and the second parking robot 200 move simultaneously, positioning information obtained through the lidar 134 among the sensing device 130 may have low reliability, and therefore, positioning information obtained through the lidar 134 may not be used.

Instead, the first parking robot 100 may identify its own position information, a relative distance to the second parking robot 100, and a preset second lower position, based on positioning information received from the second parking robot 200, and move in a corresponding direction.

For example, the first parking robot 100 may determine its own position information, for example, update its own global position, based on positioning information received from the second parking robot 200.

For example, the positioning information received from the second parking robot 200 may include position information of the second parking robot 200 and information about a relative posture of the second parking robot 200 with respect to the first parking robot 100.

The first parking robot 100 may further improve accuracy in identifying its own position information and the preset second lower position by using data obtained through the camera 132 and/or the IMU 136 in addition to the positioning information received from the second parking robot 200.

For example, image data obtained through the camera 132 may include image data of the first and second markers M3 and M4 positioned on the main body of the second parking robot 200. The first parking robot 100 may identify the first and second markers M3 and M4 positioned on the main body of the second parking robot 200 based on the image data obtained through the camera 132, and identify a relative posture with respect to the second parking robot 200 based on the first and second markers M3 and M4. The relative posture of the first parking robot 100 with respect to the second parking robot 200 may include a relative position.

Referring to FIG. 4E, the first parking robot 100 may move to the preset second lower position and the second parking robot 200 may move to the preset first lower position.

For example, the preset second lower position may correspond to the position of the rear wheels of the vehicle 10. The first parking robot 100 may temporarily stop when the center of the main body of the first parking robot 100 matches with a center of a horizontal line x′ connecting central axes of the left and right rear wheels of the vehicle 10.

For example, the preset first lower position may correspond to the position of the front wheels of the vehicle 10. The second parking robot 200 may temporarily stop when the center of the main body of the second parking robot 200 matches with the center of the horizontal line x connecting the central axes of the left and right front wheels of the vehicle 10.

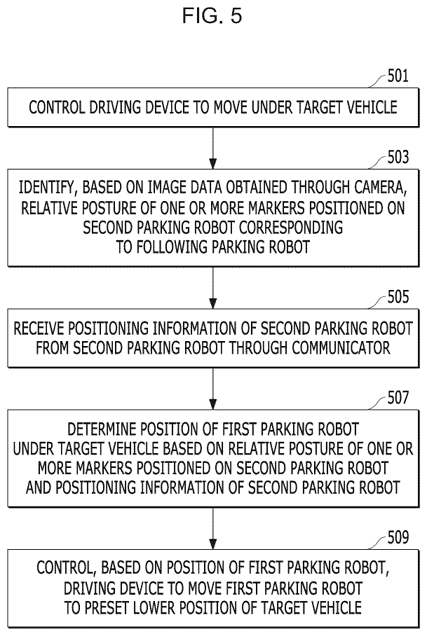

FIG. 5 is a flowchart illustrating an operation of the first parking robot 100 (and/or the controller 170) according to an embodiment.

Referring to FIG. 5, the first parking robot 100 may control the driving device 112 to cause the first parking robot 100 to move under a target vehicle 10 (501).

For example, the first parking robot 100 may identify its own position and a position of a target vehicle 10, based on image data obtained through the camera 132 and/or point cloud data obtained through the lidar 134.

The first parking robot 100 may control, based on identifying of its own position and a position of the target vehicle 10, the driver 112 to move to a preset first lower position of the target vehicle 10 and move to a preset second lower position of the target vehicle 10 from the preset first lower position.

While the first parking robot 100 controls the driver 112 to move under the target vehicle 10, the first parking robot 100 may identify, based on image data obtained through the camera 132, a relative posture of one or more markers positioned on the second parking robot 200 which corresponds to a following parking robot following the first parking robot 100 (503).

The first and second markers M3 and M4 may be positioned at both sides of a portion of the main body of the second parking robot 100, in a direction in which the second parking robot 200 moves.

For example, the first parking robot 100 may identify the first and second markers M3 and M4 included in the obtained image data, and identify a relative posture of the first and second markers M3 and M4 with respect to the first parking robot 100. For example, the relative posture may include a relative position.

The first parking robot 100 may receive positioning information of the second parking robot 200 from the second parking robot 200 through the communicator 150 (505).

The positioning information of the second parking robot 200 may include position information of the second parking robot 200 and information about a relative posture of the second parking robot 200 with respect to the first parking robot 100. The information about the relative posture of the second parking robot 200 with respect to the first parking robot 100 may include information about a relative position of the second parking robot 200 with respect to the first parking robot 100.

While the first parking robot 100 moves from the preset first lower position of the target vehicle 10 to the preset second lower position of the target vehicle 10, the first parking robot 100 may receive positioning information of the second parking robot 200 from the second parking robot 200 through the communicator 150.

The first parking robot 100 may determine its own position under the target vehicle 10 based on the relative posture of the one or more markers positioned on the second parking robot 200 and the positioning information of the second parking robot 200 (507).

The first parking robot 100 may identify a relative posture of the second parking robot 200 based on the relative posture of the first and second markers M3 and M4 of the second parking robot 200. For example, the first and second markers M3 and M4 may be positioned at both sides of a front portion of the second parking robot 200 in the main body of the second parking robot 200, thereby increasing accuracy in identifying a relative posture of the second parking robot 200 with respect to the first parking robot 100.

The first parking robot 100 may determine its own position based on the identified relative posture of the second parking robot 200 and the positioning information of the second parking robot 200 received from the second parking robot 200. That is, the first parking robot 100 may update its own position.

The first parking robot 100 may control, based on its own position, the driver 112 to move to a preset lower position of the target vehicle 10 (509).

In the above-described embodiment of FIG. 5, the first parking robot 100 may move to the preset first lower position of the target vehicle 10 and then temporarily stop, and thereafter, the first parking robot 100 may move from the preset first lower position of the target vehicle 10 to the preset second lower position of the target vehicle 10.

For example, the preset first lower position of the target vehicle 10 may correspond to the position of the front wheels of the target vehicle 10, and the preset second lower position of the target vehicle 10 may correspond to the position of the rear wheels of the target vehicle 10.

For example, the first parking robot 100 may begin moving toward the preset second lower position of the target vehicle 10 from the preset first lower position of the target vehicle 10 based on image data obtained through the camera 132 and/or information received from the second parking robot 200 through the communicator 150.

For example, the first parking robot 100 may identify whether a distance to the second parking robot 200 is a preset distance, based on analysis of image data obtained through the camera 132 and/or reception of positioning information from the second parking robot 200. Based on the distance to the second parking robot 200 being the preset distance, the first parking robot 100 may begin moving from the first lower position toward the second lower position.

As another example, the first parking robot 100 may receive a signal for beginning a movement from the second parking robot 200 through the communicator 150, and the first parking robot 100 may begin moving from the preset first lower position of the target vehicle 10 toward the preset second lower position of the target vehicle 10 based on the signal.

In addition to the above-described embodiment of FIG. 5, the first parking robot 100 may determine its own position and/or a posture under the target vehicle 10, further based on data obtained through the IMU 136.

Also, in addition to the above-described embodiment of FIG. 5, the first parking robot 100 may determine its own position based on the identified relative posture information of the second parking robot 200 and the positioning information of the second parking robot 200 received from the second parking robot 200, and control the steering device 116 to adjust a moving direction of the first parking robot 100 based on the determined position and the determined posture of the first parking robot 100.

Also, in addition to the above-described embodiment of FIG. 5, the first parking robot 100 may turn on the lighting device 140 positioned in the main body of the first parking robot 100 while the first parking robot 100 moves under the target vehicle 10.

For example, when the first parking robot 100 begins moving from the preset first lower position of the target vehicle 10 toward the preset second lower position of the target vehicle 10, the first parking robot 100 may turn on the lighting device 140.

The light device 140 may be, in consideration that while the first parking robot 100 moves in a dark space under the target vehicle 10, the second parking robot 200 which is a following parking robot may have difficulties in recognizing the markers M1 and M2 positioned on the first parking robot 100, turned on to enable the second parking robot 200 which is the following parking robot to easily recognize the markers M1 and M2 positioned above or around the lighting device 140.

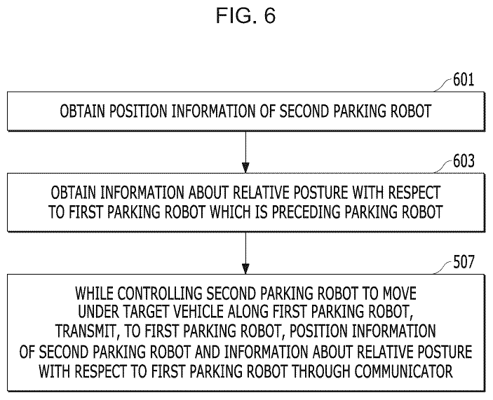

FIG. 6 is a flowchart illustrating an operation of the second parking robot 200 (and/or the controller 270) according to an embodiment.

Referring to FIG. 6, the second parking robot 200 may obtain its own position information based on image data obtained through the camera 232 and/or point cloud data obtained through the lidar 234 (601).

The second parking robot 200 may obtain information about a relative posture with respect to the first parking robot 100 corresponding to a preceding parking robot moving under a target vehicle 10, based on the position information of the second parking robot 200 and the image data obtained through the camera 232 (603).

For example, the second parking robot 200 may obtain information about a relative posture with respect to the first parking robot 100, based recognition of the markers M1 and M2 of the first parking robot 100, included in the obtained image data.

For example, the information about the relative posture with respect to the first parking robot 100 may include information about a relative position with respect to the first parking robot 100.

While the second parking robot 200 controls the driver 212 to move the second parking robot 200 under the target vehicle 10 along the first parking robot 100, the second parking robot 200 may transmit, to the first parking robot 100, position information of the second parking robot 200 and information about a relative posture with respect to the first parking robot 100 through the communicator 250 (605).

For example, the second parking robot 200 may receive a signal indicating completion of a movement to the first lower position and/or conversion into a standby state according to completion of a movement to the first lower position, from the first parking robot 100 through the communicator 250, obtain, in response to the signal, position information of the second parking robot 200 and begin moving toward the target vehicle 10 while obtaining a relative posture with respect to the first parking robot 100.

According to the first parking robot 100 moving toward the second lower position corresponding to the position of the rear wheels of the target vehicle 10 from the first lower position corresponding to the position of the front wheels of the target vehicle 10, the second parking robot 200 may move to the first lower position of the target vehicle 10.

In addition to the above-described embodiment of FIG. 6, the second parking robot 200 may turn on the lighting device 240 when entering under the target vehicle 10.

The light device 240 may be, in consideration that while the second parking robot 200 moves in a dark space under the target vehicle 10, the first parking robot 100 which is a preceding parking robot may have difficulties in recognizing the markers M3 and M4 positioned on the second parking robot 200, turned on to enable the first parking robot 100 which is the preceding parking robot to easily recognize the markers M3 and M4 positioned above or around the lighting device 240.

Also, in addition to the above-described embodiment of FIG. 6, the second parking robot 200 may identify a distance to the first parking robot 100 based on information about a relative position with respect to the first parking robot 100, and, according to the distance to the first parking robot 100 being a preset distance, the second parking robot 200 may transmit, to the first parking robot 100, a signal for causing the first parking robot 100 to begin moving to the preset second lower position of the target vehicle 10.

Meanwhile, according to the above-described embodiments of FIGS. 5 and 6, when the first parking robot 100 is located at the second lower position of the target vehicle 10 and the second parking robot 200 is located at the first lower position of the target vehicle 10, the first and second parking robots 100 and 200 may move the target vehicle 10 to a pre-designated parking area and then park the target vehicle 10 through cooperative control.

For example, according to the first parking robot 100 being located at the second lower position of the target vehicle 10 and the second parking robot 200 being located at the first lower position of the target vehicle 10, the first and second parking robots 100 and 200 may control the fork driving devices 120 and 220 to lift the target vehicle 10 and control the drivers 112 and 212 to move the target vehicle 10 to the pre-designated parking area. Thereafter, the first and second parking robots 100 and 200 may control the fork driving devices 120 and 220 to lower the target vehicle 10 and thereby park the target vehicle 10 at the corresponding area.

Also, in addition to the above-described embodiments, a wheel speed sensor may be positioned at each of the wheels of the first and second parking robots 100 and 200.

Each of the first and second parking robots 100 and 200 may determine its own moving distance and/or its own posture (or referred to as direction) based on rotation information of each wheel obtained through the wheel speed sensor by using the Wheel Odometry technology, in addition to the above-described sensing devices 130 and 230.

Also, the positions of the camera 132 and the lidar 134 of the first parking robot 100 in the above-described embodiments are only an example. The camera 132 and the lidar 134 may be installed at various locations of the first parking robot 100, and the numbers of the camera 132 and the lidar 134 of the first parking robot 100 may also vary.

Also, the number and position of the markers in the above-described embodiments are only an example, and may change depending on a designer's design.

Also, the forks in the above-described embodiments are only an example, and may be implemented in various shapes and numbers to support the wheels of the vehicle 10 and lift or lower the wheels depending on a designer's design.

In the parking robots 100 and 200 and the control method thereof according to the above-described embodiments, the first parking robot 100 and the second parking robot 200 may enter under the vehicle 10, move the vehicle 10 to a parking area, and park the vehicle 10 in the parking area, by identifying their accurate positions under the vehicle 10, that is, providing reliable positioning values through positioning supplementation between the first parking robot 100 and the second parking robot 200.

Meanwhile, the disclosed embodiments may be implemented in the form of a recording medium that stores instructions executable by a computer. The instructions may be stored in the form of program codes, and when executed by a processor, the instructions may perform operations of the disclosed embodiments by generating a program module. The recording medium may be implemented as a computer-readable recording medium.

The computer-readable recording medium may include all kinds of recording media storing instructions that can be interpreted by a computer. For example, the computer-readable recording medium may be Read Only Memory (ROM), Random Access Memory (RAM), a magnetic tape, a magnetic disc, flash memory, an optical data storage device, etc.

A machine-readable storage medium may be provided in the form of a non-transitory storage medium, wherein the term ‘non-transitory’ simply means that the storage medium is a tangible device, and does not include a signal (e.g., an electromagnetic wave), but this term does not differentiate between where data is semi-permanently stored in the storage medium and where the data is temporarily stored in the storage medium.

So far, the disclosed embodiments have been described with reference to the accompanying drawings. It will be understood by one of ordinary skill in the technical art to which the disclosure belongs that the disclosure can be embodied in different forms from the disclosed embodiments without changing the technical spirit and essential features of the disclosure. Thus, it should be understood that the disclosed embodiments described above are merely for illustrative purposes and not for limitation purposes in all aspects.

What is claimed is:

1. A parking robot comprising:
a driving device configured to move the parking robot;
a camera installed on the parking robot and configured to obtain image data;
a communicator configured to communicate with an external device; and
a controller electrically connected to the driving device, the camera, and the communicator, and
wherein the controller is configured to
while the parking robot controls the driving device to move the parking robot under a target vehicle, identify one or more markers positioned on a following parking robot following the parking robot based on the image data obtained through the camera to identify a relative posture of the one or more markers with respect to the parking robot, receive positioning information of the following parking robot from the following parking robot through the communicator,
determine a position of the parking robot under the target vehicle based on the relative posture of the one or more markers with respect to the parking robot and the positioning information of the following parking robot, and
control the driving device to move the parking robot to a preset lower position of the target vehicle based on the determined position.

2. The parking robot of claim 1, wherein the positioning information of the following parking robot includes position information of the following parking robot and information about a relative posture of the following parking robot with respect to the parking robot.

3. The parking robot of claim 1, further comprising a steering device,
wherein the controller is further configured to
determine a posture of the parking robot based on the relative posture of the one or more markers with respect to the parking robot and the positioning information of the following parking robot, and
control the steering device to adjust a moving direction of the parking robot based on the determined position and the determined posture.

4. The parking robot of claim 1, wherein the controller is configured to
control the parking robot to move to a preset first lower position of the target vehicle and then temporarily stop,
control the driving device to move the parking robot from the preset first lower position of the target vehicle to a preset second lower position of the target vehicle, and receive positioning information of the following parking robot through the communicator while the parking robot moves from the preset first lower position to the preset second lower position.

5. The parking robot of claim 4, wherein the controller is configured to
control the driving device to move the parking robot from the preset first lower position toward the preset second lower position, based on at least one of a distance to the following parking robot identified based on the image data obtained through the camera or information received from the following parking robot through the communicator.

6. The parking robot of claim 4, wherein
the preset first lower position corresponds to a position of front wheels of the target vehicle, and
the preset second lower position corresponds to a position of rear wheels of the target vehicle.

7. The parking robot of claim 1, further comprising an Inertial Measurement Unit,
wherein the controller is configured to determine the position of the parking robot under the target vehicle further based on data obtained through the inertial measure unit.

8. The parking robot of claim 1, further comprising a lidar,
wherein the controller is configured to control the driving device to move the parking robot under the target vehicle based on at least one of point cloud data obtained through the lidar or the image data obtained through the camera.

9. The parking robot of claim 1, wherein
one or more lighting devices are installed in a main body of the parking robot,
a marker is positioned above or around each of the one or more lighting devices, and
the controller is further configured to turn on the one or more lighting devices based on the parking robot moving under the target vehicle.

10. A parking robot comprising:
a driving device configured to move the parking robot;
a camera installed in the parking robot and configured to obtain image data;
a lidar installed in the parking robot and configured to obtain point cloud data;
a communicator configured to communicate with an external device; and
a controller electrically connected to the driving device, the camera, the lidar, and the communicator,
wherein the controller is configured to
obtain position information based on at least one of the image data obtained through the camera or the point cloud data obtained through the lidar,
obtain information about a relative posture with respect to a preceding parking robot moving under a target vehicle, based on the image data obtained through the camera, and
transmit the position information and the information about the relative posture with respect to the preceding parking robot to the preceding parking robot through the communicator, while controlling the driving device to move the parking robot under the target vehicle along the preceding parking robot.

11. The parking robot of claim 10, wherein
the controller is configured to control the driving device to move the parking robot to a preset first lower position corresponding to a position of front wheels of the target vehicle, along the preceding parking robot moving from the preset first lower position toward a preset second lower position corresponding to a position of rear wheels of the target vehicle.

12. The parking robot of claim 10, wherein
the controller is configured to control the driving device to move the parking robot to a preset first lower position of the target vehicle, based on at least one of the image data obtained through the camera or information received from the preceding parking robot through the communicator.

13. The parking robot of claim 10, wherein
the controller is further configured to obtain information about a relative posture with respect to the preceding parking robot, based on recognition of one or more markers of the preceding parking robot, included in the image data obtained through the camera.

14. A control method of a parking robot, the control method comprising:
controlling a driving device of the parking robot to move the parking robot under a target vehicle;
identifying, while controlling the driving device, one or more markers positioned on a following parking robot following the parking robot based on image data obtained through a camera of the parking robot to identify a relative posture of the one or more markers with respect to the parking robot, and receiving positioning information of the following parking robot from the following parking robot through a communicator of the parking robot;
determining a position of the parking robot under the target vehicle, based on the relative posture of the one or more markers with respect to the parking robot and the positioning information of the following parking robot; and
controlling the driving device to move the parking robot to a preset lower position of the target vehicle based on the determined position.

15. The control method of claim 14, wherein the positioning information of the following parking robot includes position information of the following parking robot and information about a relative posture of the following parking robot with respect to the parking robot.

16. The control method of claim 14, further comprising:
determining a posture of the parking robot based on the relative posture of the one or more markers with respect to the parking robot and the positioning information of the following parking robot, and
controlling a steering device of the parking robot to adjust a moving direction of the parking robot based on the determined position and the determined posture.

17. The control method of claim 14, wherein the controlling of the driving device comprises:
controlling the parking robot to move to a preset first lower position of the target vehicle and then temporarily stop, and
controlling the parking robot to move from the preset first lower position of the target vehicle to a preset second lower position of the target vehicle, and
the positioning information of the following parking robot is received while the parking robot moves from the preset first lower position to the preset second lower position.

18. The control method of claim 17, wherein the controlling of the parking robot to move from the preset first lower position to the preset second lower position is performed based on at least one of a distance to the following parking robot identified based on the image data obtained through the camera or information received from the following parking robot through the communicator.

19. The control method of claim 17, wherein
the preset first lower position corresponds to a position of front wheels of the target vehicle, and
the preset second lower position corresponds to a position of rear wheels of the target vehicle.

20. The control method of claim 14, further comprising
turning on one or more lighting devices installed in a main body of the parking robot based on the parking robot moving under the target vehicle,
wherein a marker is positioned above or around each of the one or more lighting devices.
